(19) United States
(12) Patent Application Publication
(10) Pub. No.: US 2026/0269987 A1
(43) Pub. Date: Sep. 10, 2026

(54) EARLY FEEDBACK USING CHANNEL POLARIZATION

(71) Applicant: Lenovo (Singapore) Pte. Limited, Singapore (SG)

(72) Inventors: Abir Ben Hadj Fredj, Wiesbaden (DE); Razvan-Andrei Stoica, Essen (DE)

(73) Assignee: Lenovo (Singapore) Pte. Limited, Singapore (SG)

(21) Appl. No.: 19/166,661

(22) PCT Filed: Mar. 20, 2024
(86) PCT No.: PCT/IB2024/052690

§ 371 Date: Sep. 18, 2025

Related U.S. Application Data
(60) Provisional application No. 63/491,344, filed on Mar. 21, 2023.

(51) Int. Cl. H04L 1/1812

(52) U.S. Cl. CPC H04L 1/1812

(57) ABSTRACT

Various aspects of the present disclosure relate to methods, apparatuses, and systems that support early feedback using channel polarization. For instance, implementations provide ways to reduce end-to-end latency when polar codes are used for channel coding by predicting and reporting hybrid automatic repeat request (HARQ) feedback ahead of a decoding process. The described implementations, for example, leverage the channel polarization aspect of polar codes to predict the failure or success of the channel decoder and transmit an early HARQ feedback to a transmitter.

### RELATED APPLICATION

This application claims priority to U.S. Provisional Application Ser. No. 63/491,344 filed Mar. 21, 2023 entitled “EARLY FEEDBACK USING CHANNEL POLARIZATION,” the disclosure of which is incorporated by reference herein in its entirety.

### TECHNICAL FIELD

The present disclosure relates to wireless communications, and more specifically to feedback in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for generating and communicating channel feedback for attempting to optimize wireless communication, such as hybrid automatic repeat-request (HARQ) feedback. However, some current channel feedback techniques can introduce channel latency into end-to-end wireless communication.

### SUMMARY

The present disclosure relates to methods, apparatuses, and systems that support early feedback using channel polarization. For instance, implementations provide ways to reduce end-to-end latency when polar codes are used for channel coding by predicting and reporting HARQ feedback ahead of a decoding process. The described implementations, for example, leverage the channel polarization aspect of polar codes to predict the failure (e.g., negative acknowledgement (NACK)) or success (acknowledgement (ACK)) of the channel decoder and transmit an early HARQ feedback to a transmitter.

By utilizing the described techniques, latency in wireless communications can be reduced and system resources can be conserved.

Some implementations of the methods and apparatuses described herein may further include performing channel estimation over a received signal to generate a channel estimate; generating virtual bit channels by performing channel polarization including channel combining and channel splitting using the channel estimate; generating bit channel metrics based at least in part on the virtual bit channels; and generating a prediction of HARQ feedback based at least in part on the bit channel metrics.

Some implementations of the methods and apparatuses described herein may further include: using the bit channel metrics to determine a subset of estimated reliable bit channel indices and a subset of estimated unreliable bit channel indices; where the bit channel metrics include one or more of Bhattacharyya parameters or bit error rates; where generating the prediction of HARQ feedback is based at least in part on a comparison of the subset of estimated reliable bit channel indices and the subset of estimated unreliable bit channel indices of a received codeword with the channel estimate; generating the prediction of HARQ feedback based at least in part on a comparison of the bit channel metrics to a threshold; determining the threshold based at least in part as a function of one or more of bit error rates, Bhattacharyya parameters, signal-to-noise ratios, or code rate.

Some implementations of the methods and apparatuses described herein may further include: generating the prediction of HARQ feedback prior to initiating a decoding process on the signal; transmitting a NACK requesting retransmission based at least in part on the prediction of HARQ feedback indicating a predicted decoding failure; transmitting the NACK prior to initiating a decoding process on the signal; performing signal decoding based at least in part on the prediction of HARQ feedback indicating a predicted decoding success; transmitting an ACK based at least in part one a successful decoding of at least a portion of the signal; where the bit channel metrics include one or more of Bhattacharyya parameters or block error rates; determining a subset of indices of estimated reliable bit channels and a subset of indices of estimated unreliable bit channels based at least in part on the bit channel metrics; generating the bit channel metrics based at least in part on log-likelihood ratios (LLRs) generated based on least in part on the signal.

Some implementations of the methods and apparatuses described herein may further include comparing false positive rate and false negative rate for early HARQ feedback to one or more thresholds to generate a comparison; and controlling the early HARQ feedback based at least in part on the comparison.

Some implementations of the methods and apparatuses described herein may further include: where the one or more thresholds are based at least in part on one or more of allowed bit error rates or allowed signal to noise ratios; determining that the false positive rate exceeds the one or more thresholds; and switching from performing early HARQ to performing early NACK; determining the false positive rate based at least in part on detection that positive early feedback (ACK) is reported to a transmitter while a received codeword is erroneous; determining the false negative rate based at least in part on detection that negative early feedback (NACK) is reported to a transmitter while a received codeword is errorless.

### BRIEF DESCRIPTION OF THE DRAWINGS

FIG. 1 illustrates an example of a wireless communications system that supports early feedback using channel polarization in accordance with aspects of the present disclosure.

FIG. 2 illustrates scenarios including different systems and use cases for wireless communications.

FIGS. 3 and 4 illustrate scenarios for uplink (UL) grant-free transmission.

FIG. 5 illustrates an implementation where a first level of a recursion combines two independent copies of a vector channel.

FIG. 6 illustrates polarization effects in accordance with aspects of the present disclosure.

FIG. 7 illustrates a scenario for early HARQ feedback in accordance with aspects of the present disclosure.

FIG. 8 illustrates an example block diagram of devices that support early feedback using channel polarization in accordance with aspects of the present disclosure.

FIGS. 9 through 12 illustrate flowcharts of methods that support early feedback using channel polarization in accordance with aspects of the present disclosure.

### DETAILED DESCRIPTION

In wireless communications systems, ultra-reliable low latency communication (URLLC) are aimed at services with stringent requirements for low end-to-end transmission latency, ultra-reliability, packet size flexibility, and availability. URLLC plays an important role in providing connectivity for new services and applications from vertical domains, such as factory automation, tactile internet, autonomous driving, and so on. To support these use cases, 3GPP release 16 defines stringent target requirements for URLLC in terms of latency (e.g., user plane latency of 1 ms) and reliability (packet error rate of 10⁻⁵). In wireless communication, one of two factors may be sacrificed to attain the other factor. For instance, to achieve a low latency, a shorter packet can be used which can cause a degradation in channel coding and result in a reliability decrease. In contrast, to improve the reliability a larger number of retransmissions can be used such as in enhanced mobile broadband (eMBB) transmission. Latency constraints, however, may limit the number of retransmissions in URLLC transmission. Moreover, if more time domain resources are consumed due to an increase of parity check bits in the low code rates, this may also increase latency and reduce system efficiency.

Accordingly, this disclosure provides for techniques that support early feedback using channel polarization. For instance, implementations provide ways to reduce end-to-end latency when polar codes are used for channel coding by predicting and reporting HARQ feedback ahead of a decoding process. The described implementations, for example, leverage the channel polarization aspect of polar codes to predict the failure (NACK) or success (ACK) of the channel decoder and transmit an early HARQ feedback to a transmitter.

For instance, implementations perform channel polarization at a receiver over a channel output and based on an assumed errorless signal detection, which can result in an assumed errorless estimated channel at the receiver. The estimated channel undergoes a polarization process, such as similar to channel polarization performed at a transmitter. This allows the synthetization of N estimated bit-channels each with different reliabilities. The reliabilities of the estimated bit-channels can be compared to a received codeword to decide if the receiver is to perform decoding of an observed sequence or report a negative HARQ feedback (NACK) to the transmitter. The latter case, for instance, can enable faster error detection. Consequently, a prediction of an erroneous codeword can be associated with an early negative HARQ feedback, enabling the reduction of subsequent retransmission times by cancelling out the decoding delays in the case of erroneous received codewords. Thus, by utilizing the described techniques, latency in wireless communications can be reduced and system resources can be conserved.

Aspects of the present disclosure are described in the context of a wireless communications system. Aspects of the present disclosure are further illustrated and described with reference to device diagrams and flowcharts.

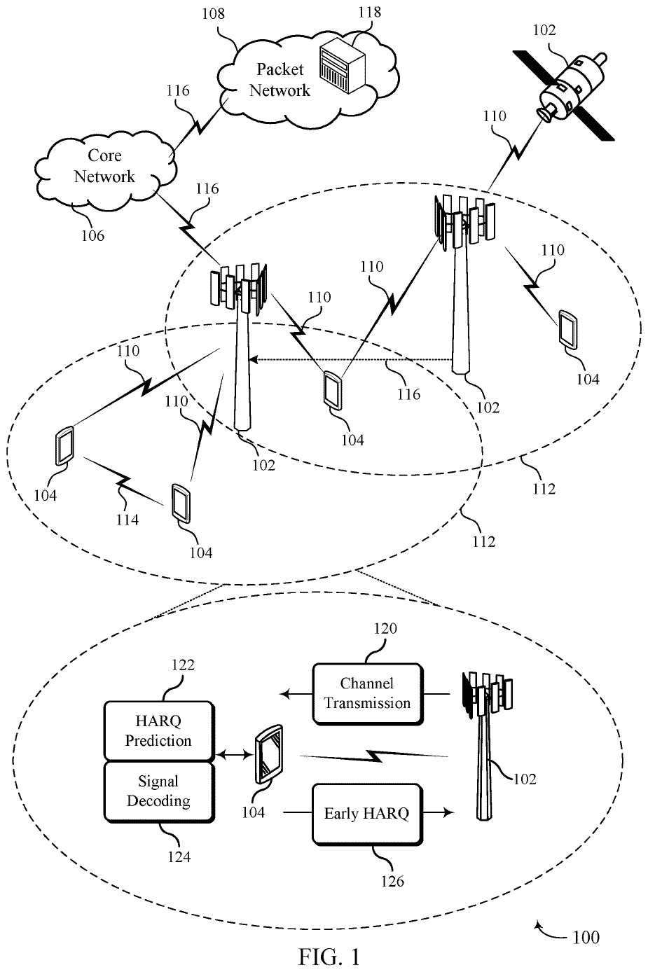

FIG. 1 illustrates an example of a wireless communications system 100 that supports early feedback using channel polarization in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for early feedback using channel polarization, a network entity 102 (e.g., a base station such as a gNB) performs channel transmission 120 to transmit a wireless signal to a UE 104. The UE 104 receives the channel transmission 120 and performs HARQ prediction 122 on the channel transmission 120. Various ways for performing the HARQ prediction 122 are detailed throughout this disclosure and in example implementations include utilizing channel polarization to generate bit channel metrics that are usable to characterize an estimated reliability of bit channel indicates generated from the channel transmission 120. As discussed herein the HARQ prediction 122 is performed prior to attempting to decode the channel transmission 120. In implementations, the HARQ prediction 122 can predict that decoding the channel transmission 120 will succeed and thus the UE 104 can perform signal decoding 124 on the channel transmission 120. The HARQ prediction 122, however, may predict that an attempt to decode the channel transmission 120 will fail and thus the UE 104 can transmit early HARQ feedback 126 to the network entity 102 based at least in part on the predicted decoding failure. The early HARQ feedback 126, for instance, includes a NACK and requests retransmission of at least a portion of the channel transmission 120.

With respect to attempting to decrease latency and comply with URLLC specifications, enhancements to channel coding procedures and feedback have been considered. Further, polar codes have been agreed to be used for eMBB control channels in 5G and thus are promising candidates for the URLLC use case. One of the bottlenecks for achieving URLLC targeted low latencies are channel decoding delays (especially in the case of polar codes where successive cancellation list decoding is used) and retransmission procedures. Early HARQ feedback has also been proposed as a solution to reduce decoding delays in the case of low-density parity check (LDPC) codes and other solutions are based on the exploitation of machine learning methods. In regular HARQ, the feedback generation is strongly coupled to the decoding process. In particular, the receiver applies the decoder on the whole signal representing the total codeword. An embedded cyclic redundancy check (CRC) enables an integrity check of the decoded bit stream. The result of this check is transmitted back as HARQ feedback, either acknowledging correct reception (ACK) or asking for further redundancy (NACK). Providing early feedback (E-HARQ) implies decoupling the feedback generation from the decoding process.

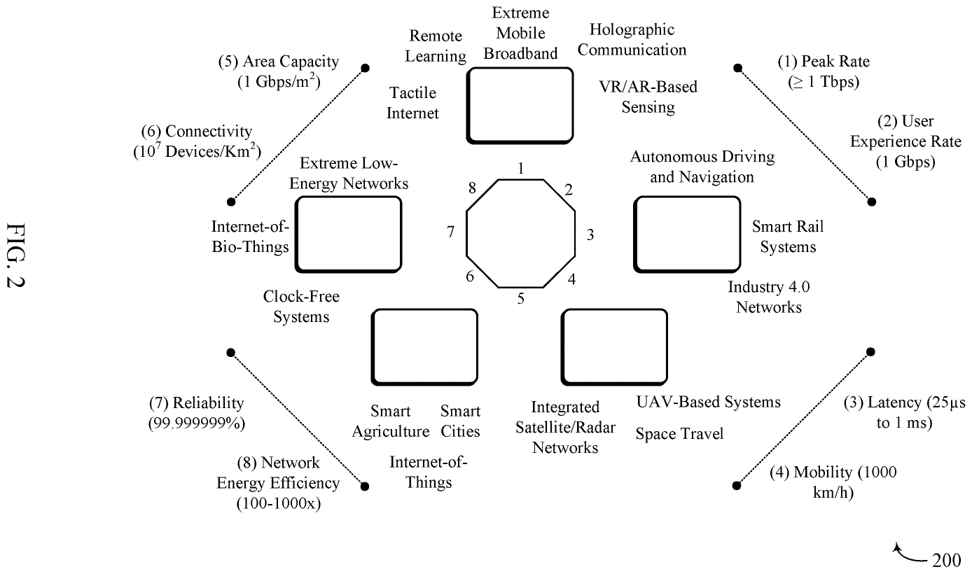

FIG. 2 illustrates scenarios 200 including different systems and use cases for wireless communications. The scenarios 200, for instance, represent systems and use cases for 6G wireless communications. In wireless communications systems, URLLC has been indicated as a critical communication scenario for beyond 5G and 6G networks. URLLC in 6G can require a significantly lower end-to-end latency (=1 ms) compared to the 5G new radio (NR) and a high level of transmission reliability, such as requiring a block error rate (BLER) of less than 10⁻⁵. URLLC may enable emerging applications, such as future factory applications, tactile internet, distributed utility grid, and metaverse, as well as mission-critical applications, such as telesurgery, autonomous driving and factory automation. Table 1 depicts some target requirements of some of these use cases, such as illustrated in the scenarios 200.

TABLE 1
Examples of ultra-reliable low latency
use cases and their target requirements

| | End-to-end | |
|---|---|---|
| Scenario | latency | Reliability |
| Discrete automation - | 1 ms | 99.9999% |
| motion control | | |
| Electricity distribution - | 5 ms | 99.9999% |
| high voltage) | | |
| Remote control | 5 ms | 99.999% |
| Discrete automation | 10 ms | 99.99% |
| Intelligent transport | 10 ms | 99.9999% |
| systems - | | |
| infrastructure backhaul | | |
| Process automation - | 50 ms | 99.9999% |
| remote control | | |
| Process automation - | 50 ms | 99.9% |
| monitoring | | |
| Electricity distribution - | 25 ms | 99.9% |
| medium voltage | | |

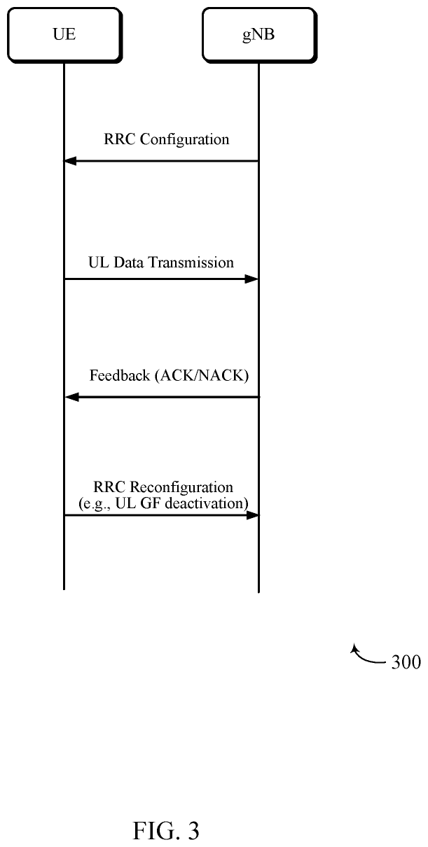

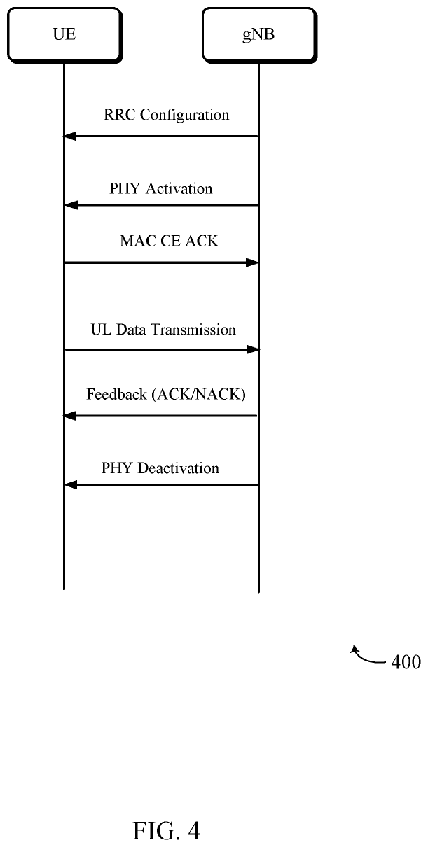

FIGS. 3 and 4 illustrate scenarios 300, 400, respectively for UL grant-free transmission. For instance, the scenario 300 illustrates an example of Type 1 UL grant-free transmission, and the scenario 400 illustrates an example of Type 2 UL grant-free transmission. In some proposals for meeting such requirements, self-contained subframes, non-slot-based scheduling, and grant-free access (as outlined in the scenarios 300, 400) have been proposed on the air interface side. For example, non-slot-based scheduling and grant-free access procedures may utilize accessing common media resources based on an active RRC configuration as showed in the scenarios 300, 400. In addition, grant-free procedures can also utilize accessing common media resources based on a medium access control (MAC) control element (CE) activation. Nonetheless, the involved UL transmissions may still rely on a HARQ mechanism for feedback regarding accuracy of transmitted and received information over-the-air. As such, the impact of previous proposals of mechanisms in deployed wireless mobile networks is still unclear. This is at least in part a consequence of the fact that fundamentally the HARQ procedure poses a bottleneck for achieving the previously mentioned latencies, as it can depend on the decoding delay of the received information.

On the other hand, short block-length codes with strong error-correction capabilities can be important in URLLC to meet the stringent latency and reliability requirements. However, in some scenarios the use of short block-length codes can degrade the transmission reliability. According to the normal approximation bound for the finite block-length regime, the theoretical maximum ratio of information bits to coded bits that can be correctly transmitted over a noisy channel significantly drops as the block-length decreases.

Polar codes have been the subject of active research, particular in view of their characteristic of being provably capacity achieving codes with explicit construction and very low complexity of encoding and decoding. The polar codes were proposed by Erdal Arikan using a novel concept called channel polarization.

In discussing polar codes, we can write W:X→Y to denote a generic binary-input, discrete, memoryless channel (B-DMC) with input alphabet X, output alphabet Y, and transition probabilities W (y|x), x∈X, y∈Y. The input alphabet X can be {0,1}, the output alphabet and the transition probabilities may be arbitrary. We can write W_{N} to denote the channel corresponding to N uses of W; thus:

$${W}_{N} : {X}_{N} \to {Y}_{N} with {W}_{N} ( {y}_{1}^{N} \vert {x}_{1}^{N} ) = {\prod }_{i = 1}^{N} W ( {y}_{i} \vert {x}_{i} ) .$$

Given a B-DMC W, there are two channel parameters of primary interest: the symmetric capacity:

$$I ( W ) = {\sum }_{y ∈ Y} {\sum }_{x ∈ X} \frac{1}{2} W ( y \vert x ) log ( \frac{w ( y \vert x )}{\frac{1}{2} w ( y \vert 0 ) + \frac{1}{2} w ( y \vert 1 )} )$$

and the Bhattacharyya parameter:

$$Z ( W ) {=}^{△} {\sum }_{y ∈ Y} \sqrt{W ( y \vert 0 ) W ( y \vert 1 )}$$

These parameters are used as measures of rate and reliability, respectively. I (W) is the highest rate at which reliable communication is possible across W using the inputs of W with equal frequency. Z (W) is an upper bound on the probability of maximum-likelihood (ML) decision error when W is used only once to transmit a 0 or 1. It is evident that Z (W) takes values in [0,1], whereby a 0 indicates a null probability of error in ML-sense, and respectively, a 1 indicates a certain probability of error in ML-sense.

In implementations channel polarization represents an operation by which one manufactures out of N independent copies of a given B-DMC W, a second set of N channels

$$\{ {W}_{N}^{( i )} : 2 \leq i \leq N \}$$

that show a polarization effect in the sense that, as N becomes large, the symmetric capacity terms

$$\{ I ( {W}_{N}^{( i )} ) \}$$

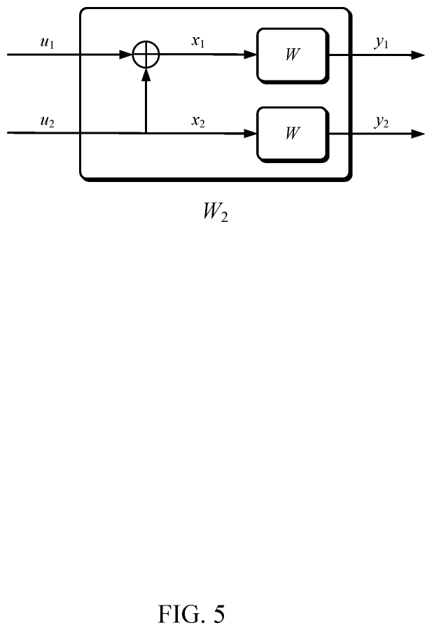

tend towards 0 or 1 for all but a vanishing fraction of indices i. This operation consists of a channel combining phase and a channel splitting phase.
1) Channel combining: This phase combines copies of a given B-DMC W in a recursive manner to produce a vector channel W_{N}:X_{N}→Y_{N}, where N can be any power of two, N=2ⁿ, n≥0. The recursion begins at the 0-th level (n=0) with only one copy of W and we set W₁ ≙W. The first level (n=1) of the recursion combines two independent copies of W₁ as shown FIG. 5 and obtains the channel W₂:X₂→Y₂ with the transition probabilities W₂(y₁,y₂|u₁,u₂)=W(y₁|u₁⊕u₂)W(y₂|u₂)
2) Channel Splitting: Having synthesized the vector channel W_{N} out of W^{N}, the next step of channel polarization is to split W_{N} back into a set of N binary-input coordinate channels

$${W}_{N}^{( i )} : X \to {Y}^{N} \times {X}^{i - 1} ,$$

1≤i≤N, defined by the transition probabilities

$${W}_{N}^{( i )} ( {y}_{1}^{N} , {u}_{1}^{i - 1} \vert {u}_{i} ) {=}^{△} {\sum }_{{u}_{i + 1}^{N} ∈ {X}^{N - i}} \frac{1}{{2}^{N - 1}} {W}_{N} ( {y}_{1}^{N} \vert {u}_{1}^{N} )$$

where

$$( {y}_{1}^{N} , {u}_{1}^{i - 1} )$$

denotes the output of

$${W}_{N}^{( i )}$$

and uᵢ its input. To gain an intuitive understanding of the channels

$$\{ {W}_{N}^{( i )} \} ,$$

consider a genie-aided successive cancellation decoder in which the ith decision element estimates uᵢ after observing

$${y}_{1}^{N}$$

and the past channel inputs

$${u}_{1}^{i - 1}$$

supplied correctly by the genie regardless of any decision errors at earlier stages). If

$${u}_{1}^{N}$$

is a-priori uniform on X^{N}, then

$${W}_{N}^{( i )}$$

is the effective channel seen by the ith decision element in this scenario.

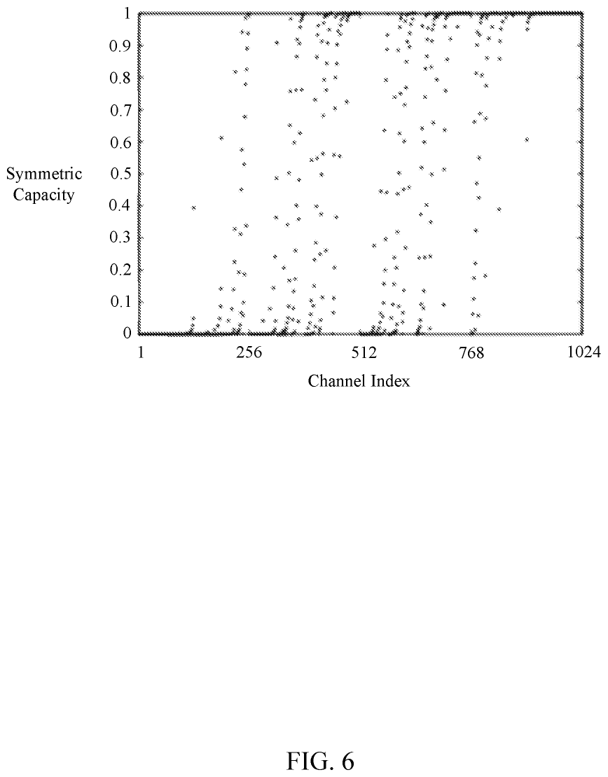

FIG. 6 illustrates polarization effects in accordance with aspects of the present disclosure. It is a known result that for any B-DMC W, the channels

$$\{ {W}_{N}^{( i )} \}$$

polarize in the sense that, for any fixed δ∈(0, 1), as N goes to infinity through powers of two, the fraction of indices i∈{1, . . . , N} for which

$$I ( {W}_{N}^{( i )} ) ∈ ( 1 - δ , 1 ]$$

goes to I(W) and the fraction for which

$$I ( {W}_{N}^{( i )} ) ∈ [ 0 , δ )$$

goes to 1−I(W). These polarization effects are illustrated in FIG. 6.

A principal concept in polar codes encoding is the splitting of data sequence indexes into two different sets before transmission. The first set includes the indexes of the data to be transmitted on the noise-free channels. The second set includes the indexes corresponding to the known frozen bits to be transmitted on the pure-noise channel. One concept for polar encoding is based on Bhattacharyya parameter bounds. In addition, a Monte-Carlo estimation approach has been suggested that can be used to construct polar codes.

Mori and Tanaka proposed a density evolution (DE) technique. This technique approximates the exact transition probability of each binary input channel to overcome difficulties in calculating the actual values of the Bhattacharyya parameter. Recently, a Gauss approximation technique has been proposed to construct polar codes by Trifonov. This technique estimates a bit channel metric inversely proportional to a defined Q-function, which represents its bit error rate (BER) under Gaussian approximation. These techniques are for the most part effective in improving the signal-to-noise ratio (SNR) for additive white Gaussian noise (AWGN) channel.

Another example polar codes construction utilizes the Bhattacharyya parameter bounds. In this case, first a generalized upper and lower bound of Bhattacharyya parameter are determined. The upper bound of this parameter corresponds to the noisiest channel, while its lower bound corresponds to the lowest noisy channel. Thus, for better performance, the gap is increased between the Bhattacharyya parameter extremes. This increases the polarization of the synthetic channels carrying the information bits. Then, the most appropriate kernel matrix is selected that is associated with Bhattacharyya parameter constraints as proposed by Karim Al Abassi, et al.

Techniques have been proposed to decode polar codes. Examples of such decoding techniques include: successive cancellation (SC), successive cancellation list (SCL), and LLR based SCL. The SC decoding technique was proposed by Arikan. It was modified to SCL by Tal for a finite small length of polar block codes. Further, Balatsoukas-Stimming proposed LLR based SCL decoding method.

As successive cancellation (SC) decoding is sub-optimal for finite length polar codes, successive cancellation list (SCL) decoding was introduced achieving the MIL bound for a sufficiently large list size L, at the cost of increased complexity due to the list decoding nature. Further enhancement of the code was conducted via concatenating a high-rate outer code such as CRC and parity-check (PC) codes. Under SCL decoding, these CRC-aided polar codes and parity-check concatenated polar codes were shown to outperform the state-of-the-art LDPC codes. Further, an extension of polar codes, namely polar subcodes, were proposed, which may outperform the above-mentioned code constructions. However, the SCL decoder is characterized by a high complexity and an inherently serial decoding nature, which in turn reduces the decoding throughput and causes high decoding latency.

In addition, SCL decoding may not be a good match to iterative detection and decoding due to its hard decision output nature (e.g., not a soft-in/soft-out decoder). Iterative decoding of polar codes based on message passing over the encoding graph has been possible through belief propagation (BP) decoders. The BP algorithm enjoys some fundamental advantages over SC-based decoding, as it can be easily parallelized, thus high throughput/low latency implementations are possible, and it inherently enables soft-in/soft-out decoding, facilitating joint iterative detection and decoding. Thus, BP decoding is a promising candidate for high data rate and low latency demanding applications. A belief propagation list (BPL) decoder with comparable performance to the successive cancellation list (SCL) decoder of polar codes, which already achieves the MIL bound of polar codes for sufficiently large list size L, was also proposed.

Pilot signals are used in wireless transmission systems to estimate the impulse response of the transmission channel. The number and the locations of the pilots can have a significant effect on the wireless system performance. Combining pilot symbols with channel coding has been proposed. The pilot symbols can be inserted within the encoded bits after the encoding process in an arrangement known as ‘external pilot insertion’. This approach has been utilized to improve the system performance. LDPC codes were combined with pilot symbols to reduce both the experienced error floor and the effect of error propagation. In addition, the problems of phase offset, frequency offset, and burst error in coherent reception for wireless communication systems were solved. Further, pilot symbols were combined with the turbo code to reduce the problem of error propagation and enhance the spectral efficiency for multiple-input multiple-output systems and multiple access sparse code systems. A pilot-assisted transmission scheme using polar codes was introduced to improve the system performance and to reduce the overhead in channel estimation.

In implementations HARQ feedback can be binary in the form of ACK/NACK with reporting done per instance of HARQ process corresponding to 1 transport block (TB) or 2 TBs (in case of spatial multiplexing with more than 4 layers). The HARQ procedure is controlled by a HARQ process within the HARQ entity of a ServiceCell as part of the MAC entity. According to 3GPP Technical Specification (TS) 38.321 (V16.7.0), Clause 5.3.2, the following procedure follows:
“The MAC entity includes a HARQ entity for each Serving Cell, which maintains a number of parallel HARQ processes. Each HARQ process is associated with a HARQ process identifier. The HARQ entity directs HARQ information and associated TBs received on the downlink shared channel (DL-SCH) to the corresponding HARQ processes (see clause 5.3.2.2).
The number of parallel DL HARQ processes per HARQ entity is specified in TS 38.214 [7]. The dedicated broadcast HARQ process is used for Broadcast Control Channel (BCCH). The HARQ process supports one TB when the physical layer is not configured for downlink spatial multiplexing. The HARQ process supports one or two TBs when the physical layer is configured for downlink spatial multiplexing.
When the MAC entity is configured with pdsch-AggregationFactor>1, the parameter pdsch-AggregationFactor provides the number of transmissions of a TB within a bundle of the downlink assignment. Bundling operation relies on the HARQ entity for invoking the same HARQ process for each transmission that is part of the same bundle. After the initial transmission, pdsch-AggregationFactor-1 HARQ retransmissions follow within a bundle.
The MAC entity shall:
   1> if a downlink assignment has been indicated:
      2> allocate the TB(s) received from the physical layer and the associated HARQ information to the HARQ process indicated by the associated HARQ information.
   1> if a downlink assignment has been indicated for the broadcast HARQ process:
      2> allocate the received TB to the broadcast HARQ process.
When a transmission takes place for the HARQ process, one or two (in case of downlink spatial multiplexing) TBs and the associated HARQ information are received from the HARQ entity.
For each received TB and associated HARQ information, the HARQ process shall:
   1> if the New-Data Indicator (NDI), when provided, has been toggled compared to the value of the previous received transmission corresponding to this TB; or
   1> if the HARQ process is equal to the broadcast process, and this is the first received transmission for the TB according to the system information schedule indicated by RRC; or
   1> if this is the very first received transmission for this TB (i.e. there is no previous NDI for this TB):
      2> consider this transmission to be a new transmission.
   1> else:
      2> consider this transmission to be a retransmission.
The MAC entity then shall:
   1> if this is a new transmission:
      2> attempt to decode the received data.
   1> else if this is a retransmission:
      2> if the data for this TB has not yet been successfully decoded:
         3> instruct the physical layer to combine the received data with the data currently in the soft buffer for this TB and attempt to decode the combined data.
   1> if the data which the MAC entity attempted to decode was successfully decoded for this TB; or
   1> if the data for this TB was successfully decoded before:
      2> if the HARQ process is equal to the broadcast process:
         3> deliver the decoded MAC PDU to upper layers.
      2> else if this is the first successful decoding of the data for this TB:
         3> deliver the decoded MAC PDU to the disassembly and demultiplexing entity.
   1> else:
      2> instruct the physical layer to replace the data in the soft buffer for this TB with the data which the MAC entity attempted to decode.
   1> if the HARQ process is associated with a transmission indicated with a Temporary C-RNTI and the Contention Resolution is not yet successful (see clause 5.1.5); or
   1> if the HARQ process is associated with a transmission indicated with a MSGB-RNTI and the Random Access procedure is not yet successfully completed (see clause 5.1.4a); or
   1> if the HARQ process is equal to the broadcast process; or
   1> if the timeAlignmentTimer, associated with the TAG containing the Serving Cell on which the HARQ feedback is to be transmitted, is stopped or expired:
      2> not instruct the physical layer to generate acknowledgement(s) of the data in this TB.
   1> else:
      2> instruct the physical layer to generate acknowledgement(s) of the data in this TB.
The MAC entity shall ignore NDI received in all downlink assignments on physical downlink control channel (PDCCH) for its Cell Temporary Radio Network Temporary Identifier (C-RNTI) when determining if NDI on PDCCH for its C-RNTI has been toggled compared to the value in the previous transmission.
NOTE: If the MAC entity receives a retransmission with a TB size different from the last TB size signalled for this TB, the UE behavior is left up to UE implementation.”

Accordingly, solutions described in this disclosure provide mechanisms and procedures to predict the outcome in terms of ACK/NACK of the successive cancellation list (SCL) decoder taking advantage of the channel polarization aspect of polar codes. The described implementations allow for transmission of early (e.g., before decoding) HARQ feedback to a transmitter which reduces the overall end-to-end latency by predicting erroneous transmissions and/or codewords ahead of the decoding algorithm. Thus, polar codes can be used as channel encoding schemes.

Implementations include the aspect of performing channel polarization at a receiver over a channel output based on an assumed errorless signal detection which results in an assumed errorless estimated channel at the receiver. The estimated channel undergoes a polarization process similar to a polarization process performed at the transmitter. This allows the synthesis of N estimated bit-channels each with different reliabilities. The reliabilities of the estimated bit-channels are compared to a received codeword to determine if the receiver is to perform SCL decoding of the observed sequence or report a negative HARQ feedback (NACK) to the transmitter. The latter case, for example, enables faster error detection. In this way, a prediction of an erroneous codeword can be associated with a an early negative HARQ feedback, enabling the reduction of subsequent retransmission times by cancelling out the decoding delays in the case of erroneous received codewords.

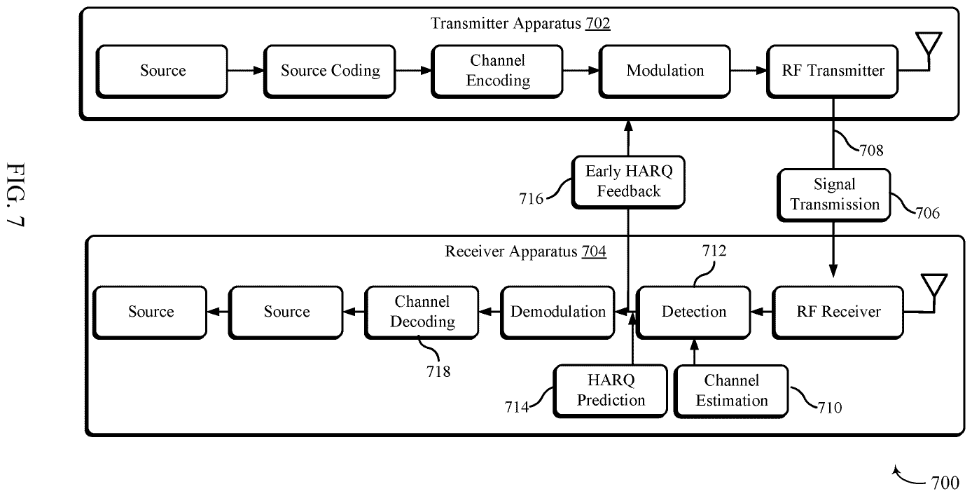

FIG. 7 illustrates a scenario 700 for early HARQ feedback in accordance with aspects of the present disclosure. The scenario 700 includes a transmitter apparatus 702 and a receiver apparatus 704. The transmitter apparatus and/or the receiver apparatus 704 may be implemented in various ways, such as a network entity 102 and/or a UE 104.

In implementations an early HARQ feedback can be predicted prior to a channel decoding process as illustrated in the scenario 700 and based on channel polarization aspects of polar codes. This can enable faster feedback and thus earlier retransmission, which can considerably reduce an overall end-to-end latency. For instance, the delay elapsed in SCL decoding can be reduced from the end-to-end latency in cases where the proposed early HARQ process (e.g., NACK detection process) detects that received codewords are erroneous.

In contrast with early HARQ schemes that rely on early stopping criterion for the decoding processes, the techniques described in this disclosure allow HARQ before performing a decoding scheme. This enables mitigation of decoding-related latency from an overall end-to-end latency, such as when a codeword cannot be decoded and a retransmission is indicated. It is worth noting that due to the sequential decoding nature and the relatively large list sizes of an SCL decoder, latency of a decoding process can be large. For instance, it has been shown that the SCL decoding process has a time complexity of O(LN log (N)), where L is the list size and N is the codeword length.

In implementations, a receiver architecture can be presented as depicted in the scenario 700 and accordingly a proposed early HARQ scheme can be described as follows. The transmitter apparatus 702 performs signal transmission 706 over a wireless channel 708. After down conversion at the receiver apparatus 704, the received signal transmission 706 undergoes channel estimation 710 and detection 712. The output is an estimated channel response H. Some implementations can assume that the channel estimation 710 is errorless.

Further to implementations, the receiver apparatus 704 performs HARQ prediction 714, e.g., before implementing channel decoding. As part of the HARQ prediction 714, the receiver apparatus 704 performs channel polarization by applying a channel combining and channel splitting procedures over the estimated channel. This transformation produces N bit-channels (ĥ₁, ĥ₂, ĥ₃, . . . , ĥ_{N}) with different polarizations and reliabilities. The bit-channel reliabilities can be evaluated in terms of Bhattacharyya parameters of the estimated bit-channels

$$\hat{h} , Z ( {\hat{h}}_{i}^{N} )$$

(an upper bound on the transmission error probability of the bit-channel with ML decision and takes values in [0,1]), which is associated with a Kernel matrix G₂. The choice of the Kernel matrix depends on the Bhattacharyya parameters and an appropriate Kernel matrix selection can positively impact the transmission.

Further to the HARQ prediction 714, two subsets of bit channel indices can be derived from previous steps: a subset of estimated reliable bit-channels indices J_{A} which can logically carry information bits and can be decoded correctly and with minimal errors using an SCL decoder with sufficient list size, and a subset of a subset of estimated unreliable bit-channels indices J_{F} which can carry the frozen bits, e.g., that are known bits to the transmitter and receiver.

Alternatively or additionally, information bits and frozen bit indices' subsets corresponding to the received codeword can be deduced. These indices subsets can be compared with the indices' subsets derived from the estimated channel polarization. In such scenarios, if the most reliable bit-channels at the receiver are different from the most reliable bit-channels assumed at the transmitter during the encoding scheme, then channel conditions between the transmission and reception may be determined to have changed which may have caused the reliable bit-channels to be unreliable and thus caused errors within the received codeword.

Alternatively or additionally, the bit-channels reliabilities and/or other bit-channel metric (e.g., BER) can be compared with a metric and/or threshold termed m which can be a function of one or more of the Bhattacharyya coefficient, the code rate, or SNR. The value of this metric/threshold can be determined empirically. Bit-channel metrics including Bhattacharyya parameters and BERs can be estimated using several methods including Gaussian approximation (GA), density evolution (DE) and Monte Carlo estimation.

Further to the scenario 700 the HARQ prediction 714 predicts HARQ feedback prior to SCL decoding. If the HARQ prediction 714 predicts a potential decoding failure, the receiver apparatus 704 transmits early HARQ feedback 716 to the transmitter apparatus 702. The early HARQ feedback 716, for instance, is a NACK that requests retransmission. The transmitter apparatus 702 can transmit a retransmission that can be combined with previous transmissions by utilizing chase combining (CC) or incremental redundancy (IR).

If the HARQ prediction 714 estimates that the signal transmission 706 can be successfully decoded, the receiver apparatus 704 can perform channel decoding 718 on the signal transmission 706. For instance, as part of the channel decoding 718 a codeword undergoes an SCL decoding process and based on the outcome of the decoding scheme, an ACK can be reported to the transmitter apparatus 702.

In implementations, the receiver apparatus 704 can split H into N bit-channels such defined as:

$$\hat{{h}_{ι}^{N}} : \{ 0 , 1 \} \to {y}^{N} \times {\{ 0 , 1 \}}^{i - 1} , where 0 \leq i \leq N - 1$$

For each

$$\hat{{h}_{ι}^{N}} ,$$

there can be a channel parameter/metric (e.g., the Bhattacharyya parameter) denoted as

$$Z ( {\hat{h}}_{i}^{N} ) .$$

It can be an upper bound on the error probability of transmission over

$$\hat{{h}_{ι}^{N}}$$

with ML decision and can takes values in [0,1]. Based on different values of

$$Z ( {\hat{h}}_{i}^{N} ) ,$$

the set [symbol] of estimated reliable bit-channels can be determined at the receiver apparatus 704. For instance, an estimated reliable channel can be a channel with Bhattacharyya parameter under 0.001 (or any number based on the PER) and an estimated unreliable channel can be a channel with Bhattacharyya parameter over 0.998.

Thus, given the SNR, the code rate and one or more of the Bhattacharyya parameters or BERs of the estimated channel, the receiver apparatus 704 can predict the HARQ feedback (ACK/NACK) prior to the decoding process. The polar code design, for instance, can be based on the channel quality indicated by the channel state information (CSI) at the transmitter apparatus 702. A channel quality change during transmission can cause an erroneous codeword at the receiver, which can impact the subsets of estimated reliable and unreliable bit-channels. Further, the comparison of the Bhattacharyya parameters, BERs, and/or other metric of the bit-channels with the metric/threshold m for a given SNR and code rate can enable the detection of the change of the channel quality between the design of the polar code and the reception of the codeword which can enable prediction of a decoding failure prior to a decoding algorithm.

In implementations, the channel H can be symmetric channels that include several channel classes of practical relevance such as the binary-input additive white Gaussian noise channel, the binary symmetric channel, and the binary erasure channel. Further, the Bhattacharyya parameter can be determined using several methods including Gaussian approximation, density evolution, Bhattacharyya parameter bounds, etc.

In implementations, negative early HARQ feedback (NACK) can include information about Bhattacharyya parameters of bit-channels, channel quality metrics, and/or a combination thereof. In such scenarios, a number of retransmissions can be minimized by adapting a design and/or rate of polar codes to channel conditions for given SNR.

In implementations, external pilot insertion can be performed after a polar code encoding scheme. For instance, pilot bits can be inserted into a codeword before transmission. The pilot bits can enable an errorless channel estimation at a receiver in scenarios where CSI is not available at the receiver and/or in scenarios of imperfect CSI.

In implementations, a receiver may not perform a thresholding procedure or a comparison of estimated reliable and unreliable bit channel indices over virtual synthesized bit channels. In such scenarios, the receiver may halt the comparison and/or thresholding when it detects a potential coding error a bit channel. This can enable faster HARQ feedback and retransmission which can reduce an overall end-to-end latency.

In implementations, LLRs of an observed sequence at a receiver apparatus y can be calculated and an estimated BER can be deduced based on the LLR values. The estimated BER can be compared with BERs of the bit-channels at the receiver apparatus. In such scenarios, an earlier detection of coding failure can allow an early NACK feedback and faster retransmissions. The LLR of the kth bit bₖ:

$$L ( {b}_{k} ) = log [ \frac{Pr ( {b}_{k} = 1 \vert y )}{Pr ( {b}_{k} = 0 \vert y )} ]$$

And the probability of wrong bit estimates could be written as follows:

$${P}_{w} ( {b}_{k} ) = \frac{1}{1 + \vert L ( {b}_{k} \vert}$$

An estimation of the BER could be determined from:

$$\text{?} = \frac{1}{M} {\sum }_{k} {P}_{W} ( {b}_{k} )$$

In implementations, a false prediction probability can be calculated, such as to reduce a number of retransmissions. For instance, providing early HARQ can imply decoupling feedback generation from the decoding process, which can introduce a misprediction probability since decoding outcome may not be known in advance. Although misprediction errors are not avoidable, the design choices for the prediction can affect system performance, e.g., requesting more retransmissions than are actually needed (e.g., over-provisioning) or less than are needed, e.g., under-provisioning.

In implementations a binary random variable f can be used to reflect feedback reported to transmitter (f=ACK) or (f=NACK) and e as the actual decoding success, e.g., e=1 which can indicate a successful decoding process and e=0 which can indicate a decoding process failure. In such implementations, false positive rate (FPR) and false negative rate (FNR) can be defined to evaluate the system performance for early HARQ. The FPR can occur when positive early feedback (ACK) has been reported to the transmitter while the received codeword is erroneous, which can result in an increased BLER and low reliability.

$$\begin{matrix}{f}_{p} = Pr ( e = 0 \vert f = ACK ) \\ = \frac{Pr ( e = 0 , f = ACK )}{Pr ( f = ACK )}\end{matrix}$$

In implementations early HARQ procedures may reduce the impact of low quality FPR (e.g., higher than 1%) by reporting only early HARQ NACKs and deferring the HARQ feedback of identified HARQ ACKs post completion of a decoding process. Further, a FNR can occur when negative early feedback (NACK) is reported to the transmitter when the received codeword is errorless which impacts the system spectral efficiency and latency by inducing unnecessary retransmissions.

$$\begin{matrix}{f}_{n} = Pr ( e = 1 \vert f = NACK ) \\ = \frac{Pr ( e = 1 , f = NACK )}{Pr ( f = NACK )}\end{matrix}$$

In implementations, different thresholds over FNR and FPR can be configured to overcome system performance degradation induced by false predictions. The thresholds can be determined empirically based on allowed BER and associated with different SNR values. According to one implementation, to avoid FNRs, an early HARQ procedure can be reduced to an early NACK Thus, in scenarios of a predicted errorless received codeword, the ACK feedback can be delayed until the completion of the channel decoding process.

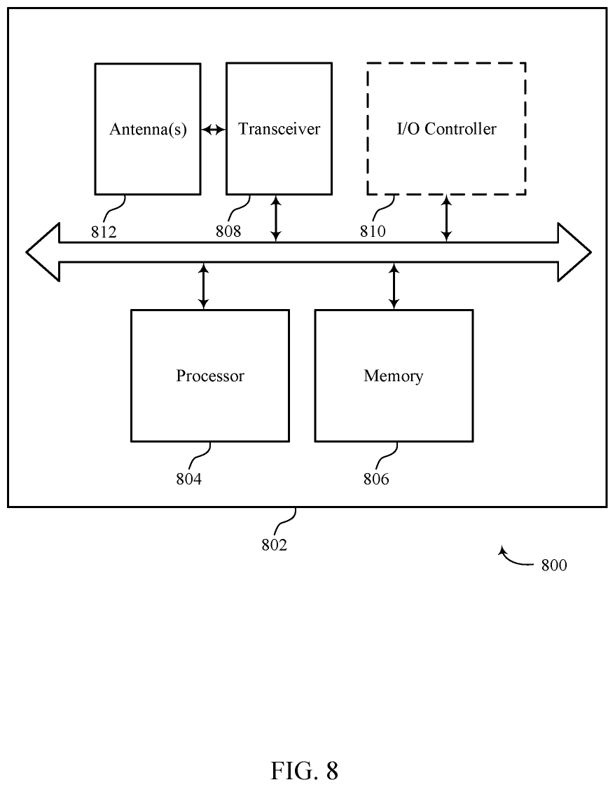

FIG. 8 illustrates an example of a block diagram 800 of a device 802 (e.g., an apparatus) that supports early feedback using channel polarization in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as and/or otherwise support a means to perform channel estimation over a received signal to generate a channel estimate; generate virtual bit channels by performing channel polarization including channel combining and channel splitting using the channel estimate; generate bit channel metrics based at least in part on the virtual bit channels; and generate a prediction of HARQ feedback based at least in part on the bit channel metrics.

Further, in some implementations, the processor 804 and/or the transceiver 808 may be configured as and/or otherwise support a means to use the bit channel metrics to determine a subset of estimated reliable bit channel indices and a subset of estimated unreliable bit channel indices; the bit channel metrics include one or more of Bhattacharyya parameters or bit error rates; the processor is configured to cause the apparatus to generate the prediction of HARQ feedback based at least in part on a comparison of the subset of estimated reliable bit channel indices and the subset of estimated unreliable bit channel indices of a received codeword with the channel estimate; the processor is configured to cause the apparatus to generate the prediction of HARQ feedback based at least in part on a comparison of the bit channel metrics to a threshold; the processor is configured to cause the apparatus to determine the threshold based at least in part as a function of one or more of bit error rates, Bhattacharyya parameters, signal-to-noise ratios, or code rate.

Further, in some implementations, the processor 804 and/or the transceiver 808 may be configured as and/or otherwise support a means to generate the prediction of HARQ feedback prior to initiating a decoding process on the signal; the processor is configured to cause the apparatus to transmit a NACK requesting retransmission based at least in part on the prediction of HARQ feedback indicating a predicted decoding failure; the processor is configured to cause the apparatus to transmit the NACK prior to initiating a decoding process on the signal; the processor is configured to cause the apparatus to perform signal decoding based at least in part on the prediction of HARQ feedback indicating a predicted decoding success; the processor is configured to cause the apparatus to transmit an ACK based at least in part one a successful decoding of at least a portion of the signal; the bit channel metrics include one or more of Bhattacharyya parameters or block error rates; the processor is configured to cause the apparatus to determine a subset of indices of estimated reliable bit channels and a subset of indices of estimated unreliable bit channels based at least in part on the bit channel metrics; the processor is configured to cause the apparatus to generate the bit channel metrics based at least in part on LLRs generated based on least in part on the signal.

For example, the processor 804 and/or the transceiver 808 may support wireless communication at the device 802 in accordance with examples as disclosed herein. For instance, the processor 804 and/or the transceiver 808 may be configured as and/or otherwise support a means to compare false positive rate and false negative rate for early HARQ feedback to one or more thresholds to generate a comparison; and control the early HARQ based at least in part on the comparison.

Further, in some implementations, the one or more thresholds are based at least in part on one or more of allowed bit error rates or allowed signal to noise ratios; the processor is configured to cause the apparatus to: determine that the false positive rate exceeds the one or more thresholds; and switch from performing early HARQ to performing early NACK; the processor is configured to cause the apparatus to determine the false positive rate based at least in part on detection that positive early feedback (ACK) is reported to a transmitter while a received codeword is erroneous; the processor is configured to cause the apparatus to determine the false negative rate based at least in part on detection that negative early feedback (NACK) is reported to a transmitter while a received codeword is errorless.

In a further example, the processor 804 and/or the transceiver 808 may support wireless communication at the device 802 in accordance with examples as disclosed herein. The processor 804 and/or the transceiver 808, for instance, may be configured as or otherwise support a means for performing channel estimation over a received signal to generate a channel estimate; generating virtual bit channels by performing channel polarization including channel combining and channel splitting using the channel estimate; generating bit channel metrics based at least in part on the virtual bit channels; and generating a prediction of HARQ feedback based at least in part on the bit channel metrics.

Further, some implementations include using the bit channel metrics to determine a subset of estimated reliable bit channel indices and a subset of estimated unreliable bit channel indices; where the bit channel metrics include one or more of Bhattacharyya parameters or bit error rates; where generating the prediction of HARQ feedback is based at least in part on a comparison of the subset of estimated reliable bit channel indices and the subset of estimated unreliable bit channel indices of a received codeword with the channel estimate; generating the prediction of HARQ feedback based at least in part on a comparison of the bit channel metrics to a threshold; determining the threshold based at least in part as a function of one or more of bit error rates, Bhattacharyya parameters, signal-to-noise ratios, or code rate.

Further, some implementations include generating the prediction of HARQ feedback prior to initiating a decoding process on the signal; transmitting a NACK requesting retransmission based at least in part on the prediction of HARQ feedback indicating a predicted decoding failure; transmitting the NACK prior to initiating a decoding process on the signal; performing signal decoding based at least in part on the prediction of HARQ feedback indicating a predicted decoding success; transmitting an ACK based at least in part one a successful decoding of at least a portion of the signal; where the bit channel metrics include one or more of Bhattacharyya parameters or block error rates; determining a subset of indices of estimated reliable bit channels and a subset of indices of estimated unreliable bit channels based at least in part on the bit channel metrics; generating the bit channel metrics based at least in part on LLRs generated based on least in part on the signal.

In a further example, the processor 804 and/or the transceiver 808 may support wireless communication at the device 802 in accordance with examples as disclosed herein. The processor 804 and/or the transceiver 808, for instance, may be configured as or otherwise support a means for comparing false positive rate and false negative rate for early HARQ feedback to one or more thresholds to generate a comparison; and controlling the early HARQ based at least in part on the comparison.

Further, in some implementations, include where the one or more thresholds are based at least in part on one or more of allowed bit error rates or allowed signal to noise ratios; determining that the false positive rate exceeds the one or more thresholds; and switching from performing early HARQ to performing early NACK; determining the false positive rate based at least in part on detection that positive early feedback (ACK) is reported to a transmitter while a received codeword is erroneous; determining the false negative rate based at least in part on detection that negative early feedback (NACK) is reported to a transmitter while a received codeword is errorless.

The processor 804 of the device 802, such as a UE 104, may support wireless communication in accordance with examples as disclosed herein. The processor 804 includes at least one controller coupled with at least one memory, and the at least one controller is configured to and/or operable to cause the processor to perform channel estimation over a received signal to generate a channel estimate; generate virtual bit channels by performing channel polarization including channel combining and channel splitting using the channel estimate; generate bit channel metrics based at least in part on the virtual bit channels; and generate a prediction of hybrid automatic repeat-request (HARQ) feedback based at least in part on the bit channel metrics. Further, the at least one controller is configured to and/or operable to cause the processor to compare false positive rate and false negative rate for early hybrid automatic repeat request HARQ feedback to one or more thresholds to generate a comparison; and control the early HARQ feedback based at least in part on the comparison. The at least one controller is configured to and/or operable to cause the processor to perform any of the various operations described herein, such as with reference to a UE 104 and/or the device 802.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M08. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

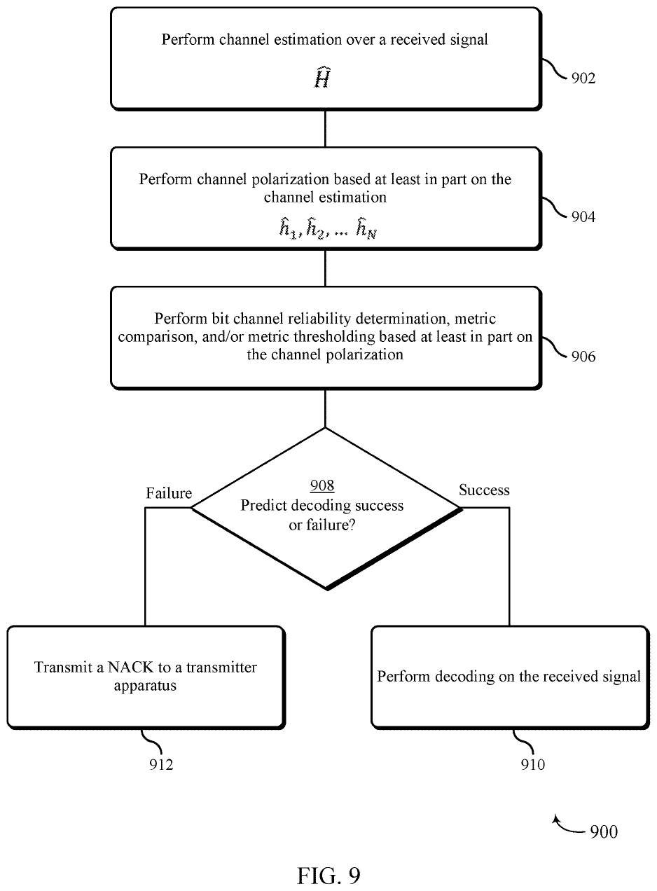

FIG. 9 illustrates a flowchart of a method 900 that supports early feedback using channel polarization in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include performing channel estimation over a received signal. In implementations performing the channel estimation produces a channel response H. The operations of 902 may be performed in accordance with examples as described herein. In some implementations, aspects of the operations of 902 may be performed by a device as described with reference to FIG. 1.

At 904, the method may include performing channel polarization based at least in part on the channel estimation. In implementations, performing the channel polarization produces a set of semi-polarized bit channels ĥ₁, ĥ₂, . . . ĥ_{N}. The operations of 904 may be performed in accordance with examples as described herein. In some implementations, aspects of the operations of 904 may be performed by a device as described with reference to FIG. 1.

At 906, the method may include performing bit channel reliability determination, metric comparison, and/or metric thresholding based at least in part on the channel polarization. The operations of 906 may be performed in accordance with examples as described herein. In some implementations, aspects of the operations of 906 may be performed by a device as described with reference to FIG. 1.

At 908, the method may include determining whether the bit channel reliability determination predicts decoding success or decoding failure for the received signal. Various ways for predicting decoding success and decoding failure are detailed throughout this disclosure. In implementations, 908 includes performing HARQ prediction such as detailed in this disclosure. The operations of 908 may be performed in accordance with examples as described herein. In some implementations, aspects of the operations of 908 may be performed by a device as described with reference to FIG. 1.

At 910, if a decoding success is predicted (“Success”), the method may include performing decoding on the received signal. In implementations, an ACK can be transmitted to a transmitter apparatus. The operations of 910 may be performed in accordance with examples as described herein. In some implementations, aspects of the operations of 910 may be performed by a device as described with reference to FIG. 1.

At 912, if a decoding failure is predicted (“Failure”), the method may include transmitting a NACK to a transmitter apparatus. The NACK, for instance, can include a request for retransmission. The operations of 912 may be performed in accordance with examples as described herein. In some implementations, aspects of the operations of 912 may be performed by a device as described with reference to FIG. 1.

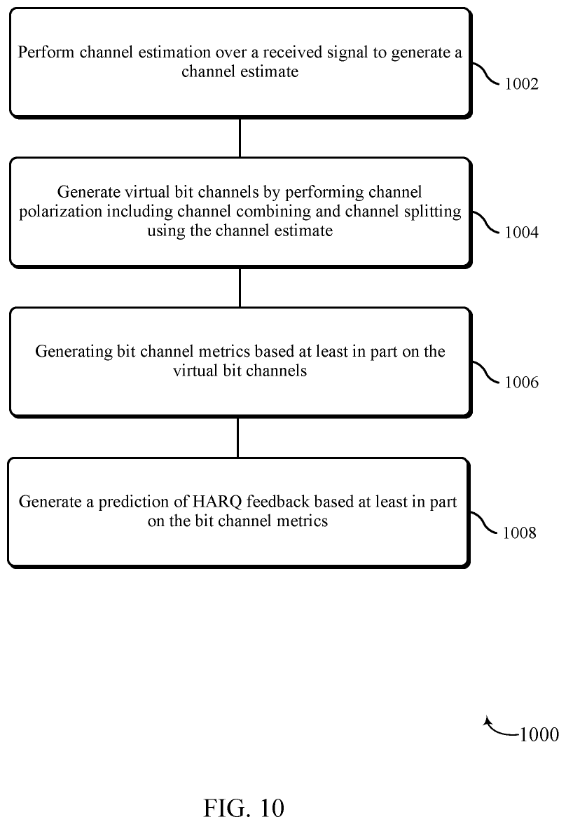

FIG. 10 illustrates a flowchart of a method 1000 that supports early feedback using channel polarization in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include performing channel estimation over a received signal to generate a channel estimate. The operations of 1002 may be performed in accordance with examples as described herein. In some implementations, aspects of the operations of 1002 may be performed by a device as described with reference to FIG. 1.

At 1004, the method may include generating virtual bit channels by performing channel polarization including channel combining and channel splitting using the channel estimate. The operations of 1004 may be performed in accordance with examples as described herein. In some implementations, aspects of the operations of 1004 may be performed by a device as described with reference to FIG. 1.

At 1006, the method may include generating bit channel metrics based at least in part on the virtual bit channels. The operations of 1006 may be performed in accordance with examples as described herein. In some implementations, aspects of the operations of 1006 may be performed by a device as described with reference to FIG. 1.

At 1008, the method may include generating a prediction of HARQ feedback based at least in part on the bit channel metrics. The operations of 1008 may be performed in accordance with examples as described herein. In some implementations, aspects of the operations of 1008 may be performed by a device as described with reference to FIG. 1.

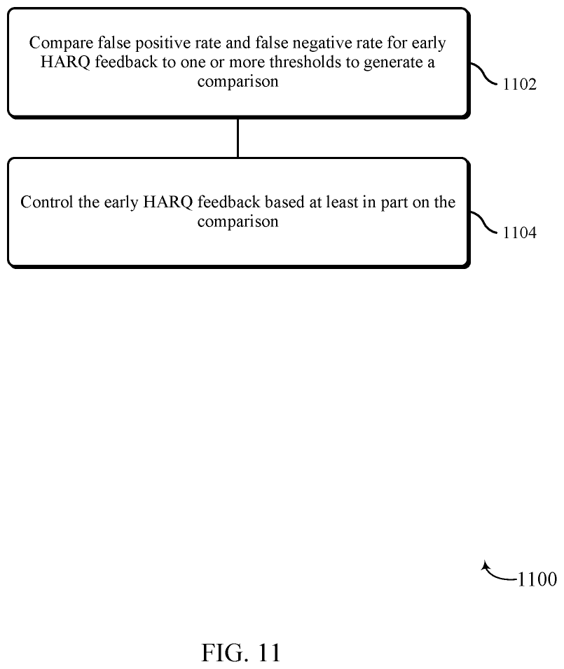

FIG. 11 illustrates a flowchart of a method 1100 that supports early feedback using channel polarization in accordance with aspects of the present disclosure. The operations of the method 1100 may be implemented by a device or its components as described herein. For example, the operations of the method 1100 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include comparing false positive rate and false negative rate for early HARQ feedback to one or more thresholds to generate a comparison. The operations of 1102 may be performed in accordance with examples as described herein. In some implementations, aspects of the operations of 1102 may be performed by a device as described with reference to FIG. 1.

At 1104, the method may include controlling the early HARQ feedback based at least in part on the comparison. The operations of 1104 may be performed in accordance with examples as described herein. In some implementations, aspects of the operations of 1104 may be performed by a device as described with reference to FIG. 1.

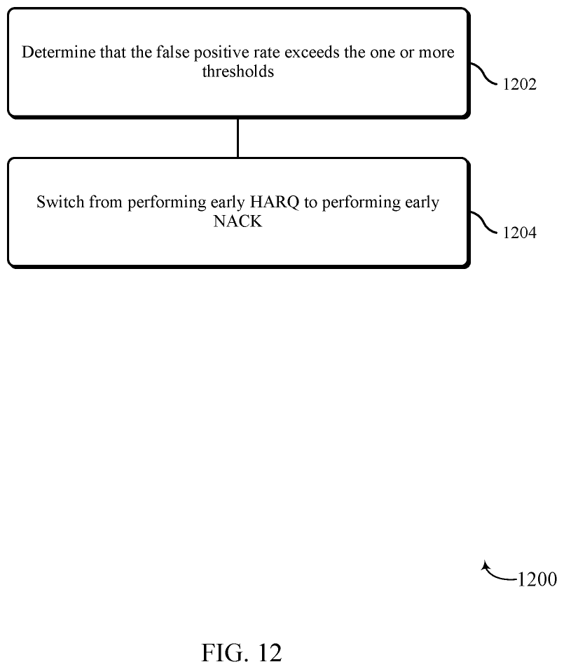

FIG. 12 illustrates a flowchart of a method 1200 that supports early feedback using channel polarization in accordance with aspects of the present disclosure. The operations of the method 1200 may be implemented by a device or its components as described herein. For example, the operations of the method 1200 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include determining that the false positive rate exceeds the one or more thresholds. The operations of 1202 may be performed in accordance with examples as described herein. In some implementations, aspects of the operations of 1202 may be performed by a device as described with reference to FIG. 1.

At 1204, the method may include switching from performing early HARQ to performing early NACK. The operations of 1204 may be performed in accordance with examples as described herein. In some implementations, aspects of the operations of 1204 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
perform channel estimation over a received signal to generate a channel estimate;
generate virtual bit channels by performing channel polarization including channel combining and channel splitting using the channel estimate;
generate bit channel metrics based at least in part on the virtual bit channels; and
generate a prediction of hybrid automatic repeat-request (HARQ) feedback based at least in part on the bit channel metrics.

2. The UE of claim 1, wherein the at least one processor is operable to cause the UE to use the bit channel metrics to determine a subset of estimated reliable bit channel indices and a subset of estimated unreliable bit channel indices.

3. The UE of claim 2, wherein the bit channel metrics comprise one or more of Bhattacharyya parameters or bit error rates.

4. The UE of claim 2, wherein the at least one processor is operable to cause the UE to generate the prediction of HARQ feedback based at least in part on a comparison of the subset of estimated reliable bit channel indices and the subset of estimated unreliable bit channel indices of a received codeword with the channel estimate.

5. The UE of claim 1, wherein the at least one processor is operable to cause the UE to generate the prediction of HARQ feedback based at least in part on a comparison of the bit channel metrics to a threshold.

6. The UE of claim 5, wherein the at least one processor is operable to cause the UE to determine the threshold based at least in part as a function of one or more of bit error rates, Bhattacharyya parameters, signal-to-noise ratios, or code rate.

7. The UE of claim 1, wherein the at least one processor is operable to cause the UE to generate the prediction of HARQ feedback prior to initiating a decoding process on the received signal.

8. The UE of claim 1, wherein the at least one processor is operable to cause the UE to transmit a negative acknowledgement (NACK) requesting retransmission based at least in part on the prediction of HARQ feedback indicating a predicted decoding failure.

9. The UE of claim 8, wherein the at least one processor is operable to cause the UE to transmit the NACK prior to initiating a decoding process on the received signal.

10. The UE of claim 1, wherein the at least one processor is operable to cause the UE to perform signal decoding based at least in part on the prediction of HARQ feedback indicating a predicted decoding success.

11. The UE of claim 10, wherein the at least one processor is operable to cause the UE to transmit an acknowledgement (ACK) based at least in part one a successful decoding of at least a portion of the received signal.

12. The UE of claim 1, wherein the bit channel metrics comprise one or more of Bhattacharyya parameters or block error rates.

13. The UE of claim 1, wherein the at least one processor is operable to cause the UE to determine a subset of indices of estimated reliable bit channels and a subset of indices of estimated unreliable bit channels based at least in part on the bit channel metrics.

14. The UE of claim 1, wherein the at least one processor is operable to cause the UE to generate the bit channel metrics based at least in part on log-likelihood ratios (LLRs) generated based on least in part on the received signal.

15. (canceled)

16. (canceled)

17. (canceled)

18. (canceled)

19. A method performed by a user equipment (UE), the method comprising:
performing channel estimation over a received signal to generate a channel estimate;
generating virtual bit channels by performing channel polarization including channel combining and channel splitting using the channel estimate;
generating bit channel metrics based at least in part on the virtual bit channels; and
generating a prediction of hybrid automatic repeat-request (HARQ) feedback based at least in part on the bit channel metrics.

20. A user equipment (UE) for wireless communication, comprising:
at least one memory; and
at least one processor coupled with the at least one memory and operable to cause the UE to:
compare false positive rate and false negative rate for early hybrid automatic repeat request (HARQ) feedback to one or more thresholds to generate a comparison; and
control the early HARQ feedback based at least in part on the comparison.

21. A method performed by a user equipment (UE), the method comprising:
comparing false positive rate and false negative rate for early hybrid automatic repeat request (HARQ) feedback to one or more thresholds to generate a comparison; and
controlling the early HARQ feedback based at least in part on the comparison.

22. The method of claim 19, further comprising using the bit channel metrics to determine a subset of estimated reliable bit channel indices and a subset of estimated unreliable bit channel indices.

23. The method of claim 22, wherein the bit channel metrics comprise one or more of Bhattacharyya parameters or bit error rates.

24. The method of claim 22, generate the prediction of HARQ feedback based at least in part on a comparison of the subset of estimated reliable bit channel indices and the subset of estimated unreliable bit channel indices of a received codeword with the channel estimate.
